(19) United States
(12) Patent Application Publication
(10) Pub. No.: US 2025/0111571 A1
(43) Pub. Date: Apr. 3, 2025

(54) TEXT ANIMATION GENERATION METHOD AND APPARATUS, ELECTRONIC DEVICE, AND STORAGE MEDIUM

(71) Applicant: Beijing Zitiao Network Technology Co., Ltd., Beijing (CN)

(72) Inventor: ZEHUA BAO, Beijing (CN)

(21) Appl. No.: 18/900,380

(22) Filed: Sep. 27, 2024

(30) Foreign Application Priority Data
Sep. 28, 2023 (CN) 202311278187.7

(51) Int. Cl. G06T 13/20; G06T 11/00; G06T 13/80

(52) U.S. Cl. CPC G06T 13/20; G06T 11/001; G06T 13/80

(57) ABSTRACT

The embodiments of the present disclosure provide a text animation generation method and apparatus, an electronic device, and a storage medium. The text animation generation method includes: in response to a first user operation, acquiring a target text and reference data corresponding to the target text, the reference data being used for indicating a font effect of an effect text generated based on the target text; generating a text image according to the target text and the reference data, the text image including the effect text corresponding to the target text; and generating a text animation corresponding to the effect text according to the text image.

### CROSS-REFERENCE TO RELATED APPLICATION

This application claims the priority to and benefits of the Chinese patent application No. 202311278187.7, which was filed on Sep. 28, 2023. All the aforementioned patent application is hereby incorporated by reference in their entireties.

### TECHNICAL FIELD

The embodiments of the present disclosure relate to a text animation generation method and apparatus, an electronic device, and a storage medium.

### BACKGROUND

An effect text is usually an effect font generated by adding extra effects on the basis of basic fonts, which have better visual effects than ordinary fonts. At present, it is a common image editing method to insert the effect texts into pictures and videos to improve the visual expression of the videos and the images.

In some cases, the generation of the effect text is usually based on effect text templates. For example, in an image editing application or platform, by presetting several effect text templates, a user can generate the effect texts by calling such effect text templates to meet the user's needs of inserting the effect texts into the images.

However, in some schemes, only static effect texts with preset styles can be generated, which leads to the problems of single style and poor visual effect of the generated effect text.

### SUMMARY

The embodiments of the present disclosure provide a text animation generation method and apparatus, an electronic device, and a storage medium, so as to overcome the problem that the generated artistic text has a single style and poor visual effect.

An embodiment of the present disclosure provides a text animation generation method, which comprises the following steps:
in response to a first user operation, acquiring a target text and reference data corresponding to the target text, the reference data being used for indicating a font effect of an effect text generated based on the target text; generating a text image according to the target text and the reference data, the text image comprising the effect text corresponding to the target text; and generating a text animation corresponding to the effect text according to the text image.

An embodiment of the present disclosure provides a text animation generation apparatus, which comprises:
an interaction module, configured to: in response to a first user operation, acquire a target text and reference data corresponding to the target text, the reference data being used for indicating a font effect of an effect text generated based on the target text;
a processing module, configured to generate a text image according to the target text and the reference data, the text image comprising the effect text corresponding to the target text; and
a generation module, configured to generate a text animation corresponding to the effect text according to the text image.

An embodiment of the present disclosure provides an electronic device, which comprises a processor and a memory. The memory stores computer executable instructions, and the processor executes the computer executable instructions stored in the memory, such that at least one processor executes the text animation generation method according to any embodiment of the present disclosure.

An embodiment of the present disclosure provides a non-transitory computer-readable storage medium, the non-transitory computer-readable storage medium stores computer executable instructions, and when the computer executable instructions are executed by a processor, the text animation generation method according to any embodiment of the present disclosure is implemented.

An embodiment of the present disclosure provides a computer program product, including a computer program, and the computer program, when executed by a processor, implements the text animation generation method according to any embodiment of the present disclosure.

### BRIEF DESCRIPTION OF DRAWINGS

In order to illustrate the technical solutions of the embodiments of the present disclosure more clearly, the accompanying drawings needed to be used in the description of the embodiments will be briefly introduced below; it will be apparent that the accompanying drawings in the following description are some embodiments of the present disclosure, and that other accompanying drawings can also be obtained according to these drawings by those ordinarily skilled in the art without creative efforts.

FIG. 1 is an application scenario diagram of a text animation generation method provided by an embodiment of the present disclosure;

FIG. 2 is a flowchart of a text animation generation method provided by an embodiment of the present disclosure;

FIG. 3 is a flowchart of a specific implementation of step S102 in the embodiment shown in FIG. 2;

FIG. 4 is a flowchart of a specific implementation of step S1021 in the embodiment shown in FIG. 3;

FIG. 5 is a schematic diagram of a process of generating an input image provided by an embodiment of the present disclosure;

FIG. 6 is a flowchart of a specific implementation of step S103 in the embodiment shown in FIG. 2;

FIG. 7 is a schematic diagram of a process of generating a two-dimensional skeleton animation provided by an embodiment of the present disclosure;

FIG. 8 is a flowchart of another text animation generation method provided by an embodiment of the present disclosure;

FIG. 9 is a flowchart of a specific implementation of step S205 in the embodiment shown in FIG. 6;

FIG. 10 is a schematic diagram of generating a sequence frame animation provided by an embodiment of the present disclosure;

FIG. 11 is a schematic diagram of a process for generating a plurality of simulation images provided by an embodiment of the present disclosure;

FIG. 12 is a structural block diagram of a text animation generation apparatus provided by an embodiment of the present disclosure;

FIG. 13 is a schematic structural diagram of an electronic device provided by an embodiment of the present disclosure; and

FIG. 14 is a schematic diagram of a hardware structure of an electronic device provided by an embodiment of the present disclosure.

### DETAILED DESCRIPTION

In order to make the purpose, technical solutions, and advantages of the embodiment of the present disclosure clearer, the technical solutions in the embodiments of the present disclosure will be described clearly and completely in the following in conjunction with the accompanying drawings in the embodiments of present disclosure. Obviously, the described embodiments are a part of the embodiments of the present disclosure and not all of the embodiments of the present disclosure. Based on the embodiments in the present disclosure, all other embodiments obtained by a person of ordinary skill in the art without creative efforts belong to the protection scope of the present disclosure.

It should be noted that the user information (including but not limited to user device information, user personal information, etc.) and data (including but not limited to data used for analysis, stored data, displayed data, etc.) involved in the present disclosure are all information and data authorized by users or fully authorized by all parties, and the collection, use, and processing of relevant data need to comply with relevant laws, regulations, and standards of relevant countries and regions, and corresponding operation interfaces are provided for users to choose authorization or rejection.

In the text animation generation method and apparatus, the electronic device, and the storage medium provided by the embodiments of the present disclosure, a target text and corresponding reference data are obtained in response to a first user operation, and the reference data is used to indicate a font effect of an effect text generated based on the target text; a text image is generated according to the target text and the reference data, the text image comprises the effect text corresponding to the target text; a text animation corresponding to the effect text is generated according to the text image. By using the reference data to convert the target text into the text image, and then convert the text image into the text animation, so that the effect text that changes dynamically can be obtained, thus improving the visual expression and diversity of the effect text.

The application scenario of the embodiments of the present disclosure is explained below:

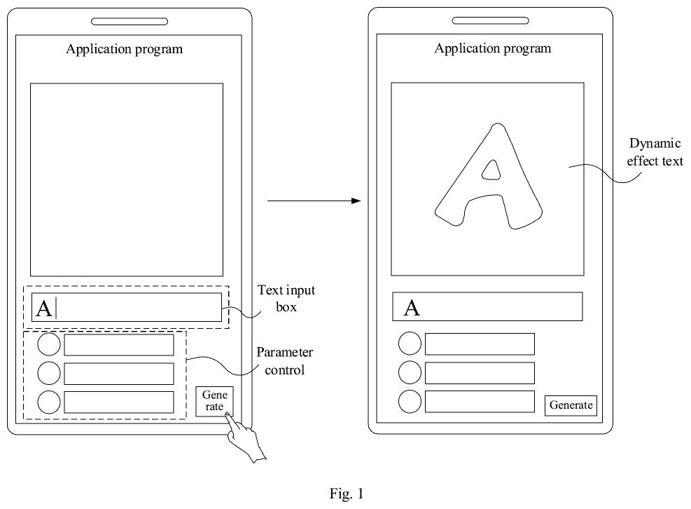

FIG. 1 is an application scenario diagram of a text animation generation method provided by an embodiment of the present disclosure. The text animation generation method provided by the embodiments of the present disclosure can be applied to an application program with a font effect production function, and more specifically, can be applied to an application scenario of effect text design, production, and editing. The execution subject of the embodiment may be a terminal device that runs the above-mentioned application program with the font effect production function, may also be a server that runs a server side corresponding to the above-mentioned application program, or other electronic devices with similar functions. Referring to FIG. 1, taking a terminal device as an example, after running an application program with the font effect production function, the terminal device displays a text input box and a parameter control within an interface of the application program, the text input box is used for inputting a target text (shown as the letter “A” in the figure), and the parameter control is used for controlling the effect style of the effect text generated based on the target text. After the user, by operating the terminal device, inputs the target text in the text input box and completes the configuration of the parameter control, the user clicks a control of “Generate” to generate a dynamic effect text corresponding to the target text. The effect text, which can also be referred to as artistic font, is a text with an effect font. Compared with a static effect text, the font shape and/or font texture of the dynamic effect text will change dynamically over time, that is, text animation. After that, the generated text animation can be further inserted into a carrier such as a video and an image to generate a video and a sequence of frames with the text animation. Therefore, the above video and the sequence of frames can achieve better visual effects while displaying the text information.

In some cases, the generation of the effect text is usually implemented based on effect text templates, such as artistic text templates. For example, in an image editing application or platform, by presetting several effect text templates, a user can generate effect texts by calling such effect text templates to meet the needs of the user to insert effect texts into image carriers. However, the scheme of generating the effect texts in the prior art can only generate static effect texts with preset styles based on the effect text style templates, but cannot achieve to generate more personalized dynamic effect texts, which leads to the problems that the generated effect text has the single style and the poor visual effect.

The embodiments of the present disclosure provide a text animation generation method to solve the above problems.

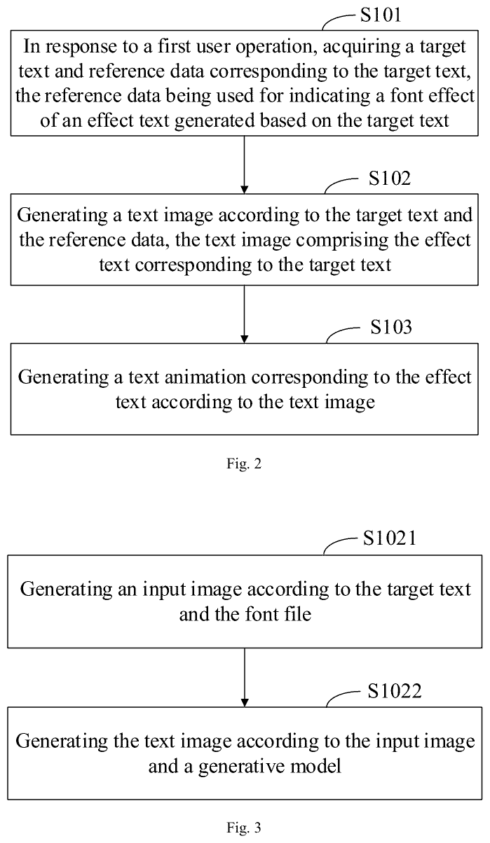

Referring to FIG. 2, FIG. 2 is a flowchart of a text animation generation method provided by an embodiment of the present disclosure. The method of the embodiment can be applied to a terminal device or a server, and the text animation generation method includes the following steps S101-S103.

Step S101: in response to a first user operation, acquiring a target text and reference data corresponding to the target text, the reference data being used for indicating a font effect of an effect text generated based on the target text.

For example, referring to the schematic diagram of the application scenario shown in FIG. 1, taking a case that the terminal device is the execution subject of the method of the embodiment as an example, after the terminal device runs a target application program having an effect text generation function, the terminal device displays an application program interface for responding to a user operation. Afterwards, the terminal device responds to the first user operation by means of, for example, the input box and the parameter control in the application program interface shown in FIG. 1, and obtains the corresponding target text and the corresponding reference data. The target text is a text used for generating the effect text in the subsequent step, and the reference data is used to indicate the font effect of the effect text generated based on the target text, the effect text is a flat font with the font effect. In one possible implementation, the reference data includes, for example, font type, such as SongTi, and KaiTi; font color; language type, etc. Further, the reference data can also include the texture features of the generated effect text. With the reference data, the font effect of the effect text corresponding to the generated target text can be controlled.

It can be understood that in other possible implementations, the first user operation can also be implemented in other ways. For example, the first user operation is used to control the terminal device to load the target file, and then the terminal device obtains the target text and the corresponding reference data according to the contents in the loaded target file. The specific implementation method is not limited and can be set as required.

Step S102: generating a text image according to the target text and the reference data, the text image comprising the effect text corresponding to the target text.

For example, after the terminal device obtains the target text and the reference data, the terminal device processes the target text by using the generative model to obtain the corresponding text image. The text image can only comprise the effect text corresponding to the target text, or can also comprise the effect text corresponding to the target text and a corresponding background image, such as a solid color background image or a background image with other image contents, which can be set according to specific needs and is not limited here.

In one possible implementation, the reference data includes a font file based on a target language, or information indicating the font file based on the target language. As shown in FIG. 3, the specific implementation of step S102 includes:

Step S1021: generating an input image according to the target text and the font file.

Step S1022: generating the text image according to the input image and a generative model.

Illustratively, the font file is a font-library file used to implement a specific type of font, such as a TTF (TrueTypeFont) file and the like. Different languages correspond to different font files. In one implementation, the reference data comprises an identifier indicating the font file of the target language (for example, English), and the terminal device obtains the corresponding font file through the above-mentioned identifier and loads the corresponding font file, thus implementing to acquire the font file. Afterwards, the terminal device executes the process of converting text into image (text-to-image) through the target text and the corresponding font file to obtain the corresponding input image. After that, the input image is further processed to generate a text image with a font effect.

In one possible implementation, the implementation of generating the input image includes: after converting the target text into a text picture including the above-mentioned target text based on the font file, identifying a glyph outline in the text picture, and processing the glyph outline, such as changing the shape of the glyph outline, more specifically, for example, changing the contour lines of the glyph outline from straight lines or curve lines to wavy lines, so as to obtain the input image.

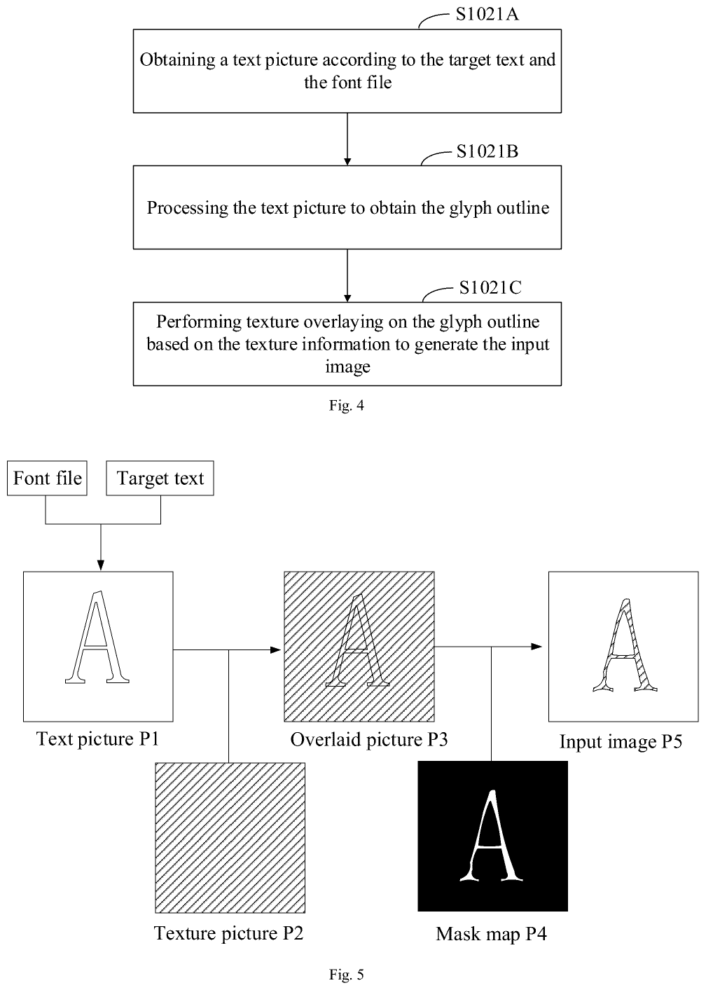

In another possible implementation, a more complex input image can be generated by adding textures. For example, the reference data includes texture information, the texture information represents the texture features of the input image, as shown in FIG. 4, the specific implementation of step S1021 includes:
Step S1021A: obtaining a text picture according to the target text and the font file;
Step S1021B: processing the text picture to obtain the glyph outline;
Step S1021C: performing texture overlaying on the glyph outline based on the texture information to generate the input image.

For example, after the text picture is obtained according to the target text and the font file, the glyph outline of the target text in the text picture can be obtained by processing the text picture, such as performing glyph outline recognition. Specifically, the obtained glyph outline can be, for example, pixel coordinate points describing the glyph outline or a layer used to characterize the glyph outline. Then, based on the texture characterized by the texture information, the corresponding texture data or file is obtained from a texture library, and the texture is superimposed onto the inside of the glyph outline, thus generating the input image with the texture features.

Further, in another possible implementation, the font shape can be changed by adding a mask map, so as to obtain the input image of the target font comprising the font shape, and further obtain the personalized effect text meeting the needs of the user. Specifically, for example, the reference data includes a mask map, and the mask map is used to characterize a display region of the input image. The specific implementation of step S1021 includes:
Step S1021A: obtaining a text picture according to the target text and the font file;
Step S1021B: processing the text picture to obtain the glyph outline.
Step S1021D: generating the input image through the mask map and the glyph outline.

For example, referring to the introduction in the steps of the previous embodiment, after the glyph outline is obtained, the glyph outline can be further processed based on a mask, the mask can be an image used to mask the target text in the text picture to change the shape and the appearance of the target text, such as a “shutter” picture. Under the action of the mask, part content of the target text in the text picture is displayed, while part content of the target text is masked, thus achieving the purpose of changing the font shape.

In the above-mentioned steps of obtaining the input image, the step of overlaying the texture on the text image and the step of overlaying the mask on the text image can be separately executed to generate the input image, or can be successively executed to generate the input image. In the scheme of sequentially executing the above-mentioned overlaying the texture and overlaying the mask, the execution order of the two steps can be set as required, and is not specifically limited here.

FIG. 5 is a schematic diagram of a process of generating an input image provided by an embodiment of the present disclosure, and the above process will be further described below in combination with FIG. 5. Referring to FIG. 5, a text picture, such as a picture P1 comprising the letter “A” shown in the figure, is generated after performing text-to-picture processing on the target text and the font file; then, according to the texture information, a texture picture P2 is overlaid on the text picture P1 to obtain an overlaid picture P3, and further, a mask map P4 is overlaid on the overlaid picture P3 to further adjust the appearance of the target text “A” to obtain an input image P5 comprising the target text with the above appearance and texture.

In the step of the embodiment, the texture and shape of the text in the input image are adjusted through the texture information and/or mask information, so that in the subsequent steps, the effect text and the text animation generated based on the input image can meet the personalized needs of the user, and the visual presentation and the diversity of the text animation are improved.

Illustratively, further, after the input image is obtained, the input image can be further processed to generate the effect text. One possible implementation is to add a color style filter to the input image to change the color of the font in the input image, so as to obtain the effect text. In another possible implementation, the input image can be processed by using a generative model of an image-to-image (img2img) mode, so as to obtain the corresponding effect text.

Illustratively, the specific implementation of step S1022 includes:

Step S1022A: obtaining description word information.

Step S1022B: processing the description word information and the input image through the generative model that is pre-trained to generate the text image.

In fact, for example, the description word information (prompt) is information used to describe a content generation feature and a content generation direction of the generative model, and can be obtained through the second user operation. For example, in the interface of the application program, a text box for inputting the description word information is provided, and the user inputs the text into the text box through the second user operation, so that the terminal device can obtain the description word information. More specifically, the description word information can be input based on the user's needs, such as “flame”, “cold winter”, and so on. After that, the generative model can get the user's intention characterized by the description word information by performing semantic feature extraction on the description word information, and then proceed to content generation to obtain the text image, so that the effect text in the text image has the font effect, the effect style of which matches the user's intention characterized by the description word information, on the basis of the input image.

Further, before the text image is generated through the pre-trained generative model, for example, a step of configuring the generative model may be included, specifically, for example, in response to a third user operation, a model plug-in is configured for the generative model, and the model plug-in is used to enable the generative model to generate an image with a target image style. The model plug-in can be an open source plug-in, or of course can also be other customized plug-ins, which can be selected as needed. Through the model plug-in, the image style and the image effect of the image generated by the generative model can be set, for example, through the open source plug-in, the generative model can generate the cartoon-style image, and so on, so as to further improve the actual effect of the text image generated by the generative model and improve the personalized needs of users.

The specific training and using methods of the generative model, and the specific execution process of generating the image through the generative model in the embodiment are not described in details here.

Step S103: generating a text animation corresponding to the effect text according to the text image.

Further, after the text image generated by the generative model is obtained, the text image is further processed to obtain an image comprising a dynamic effect text, that is, text animation. Specifically, in one possible implementation, a three-dimensional model, that is, a three-dimensional effect text model, corresponding to the effect text in the text image can be created by three-dimensionalizing the text image. Then, based on the three-dimensional effect text model, the effect text can be mapped two-dimensionally from different angles, so as to obtain a plurality of frames of images including the artistic text, and then generate the text animation based on the above-mentioned plurality of frames of images. The visual effect of the text animation is, for example, a rotating “A” letter. In another possible implementation, different font textures and colors can be added to the effect text based on the text image, so as to generate a plurality of frames of images including artistic texts with different appearances, or directly generate a plurality of frames of text images with different appearances, and then generate the text animation based on the above-mentioned plurality of frames of images or text images, for example, the text animation may be an “A” letter with a changing appearance. The above steps of three-dimensionalizing the text image, adding and generating different font appearances to the text image can be achieved by the pre-trained generative model, which is not repeated here.

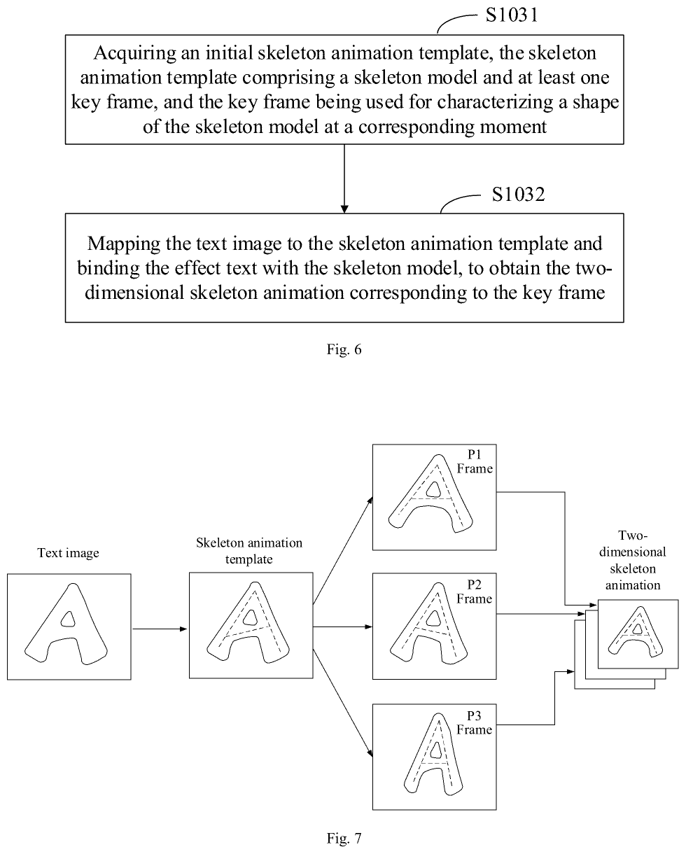

In one possible implementation, the text animation at least includes two-dimensional skeleton animation, and the two-dimensional skeleton animation is used to show the glyph change of the effect text, as shown in FIG. 6, the specific implementation of step S103 includes:

Step S1031: acquiring an initial skeleton animation template, the skeleton animation template comprising a skeleton model and at least one key frame, and the key frame being used for characterizing a shape of the skeleton model at a corresponding moment.

Step S1032: mapping the text image to the skeleton animation template and binding the effect text with the skeleton model, to obtain the two-dimensional skeleton animation corresponding to the key frame.

For example, the skeleton animation is a kind of model animation. In the skeleton animation, the model has a skeleton structure composed of interconnected “skeletons”, and the animation is generated by changing the orientations and positions of the “skeletons”. Specifically, the skeleton animation template includes a surface model and skeletons bound to the surface model, namely the skeleton model, and key frames corresponding to the skeleton model. By setting key frames (k frames) for the skeleton, the shape of the skeleton model at the corresponding moment is set, and then corresponding pictures are generated in order at least for each key frame, so that the “motion effect” of the skeleton model can be achieved. Based on the above description, after the initial skeleton animation template is obtained, the effect text in the text image is mapped to the skeleton animation template to implement the binding between the effect text and the skeleton model. Then, for each key frame, corresponding image frames including the effect text moving with the skeleton model are generated, and based on the above orderly generated image frames, two-dimensional skeleton animation can be obtained.

FIG. 7 is a schematic diagram of a process of generating a two-dimensional skeleton animation provided by an embodiment of the present disclosure. Referring to FIG. 7, after a preset skeleton animation template is obtained, a text image is mapped to the skeleton animation template, and then corresponding skeleton motion frames, such as P1 frame, P2 frame, and P3 frame shown in the figure, are generated based on the motion rules of the skeleton model determined by the key frames of the skeleton animation template. In each skeleton motion frame, the outline shape of the effect text changes with the movement of the skeleton model, resulting in the dynamic effect, and then the two-dimensional skeleton animation is generated based on a collection of a plurality of skeleton motion frames.

The text animation generation method provided by the embodiment of the present disclosure comprises acquiring a target text and corresponding reference data in response to a first user operation, and the reference data being used for indicating a font effect of an effect text generated based on the target text; generating a text image according to the target text and the reference data, the text image comprising the effect text corresponding to the target text; and generating a text animation corresponding to the effect text according to the text image. By using the reference data to convert the target text into the text image, and then converting the text image into the text animation, so that the artistic text that dynamically changes can be obtained, thus improving the visual expression and the diversity of the artistic text.

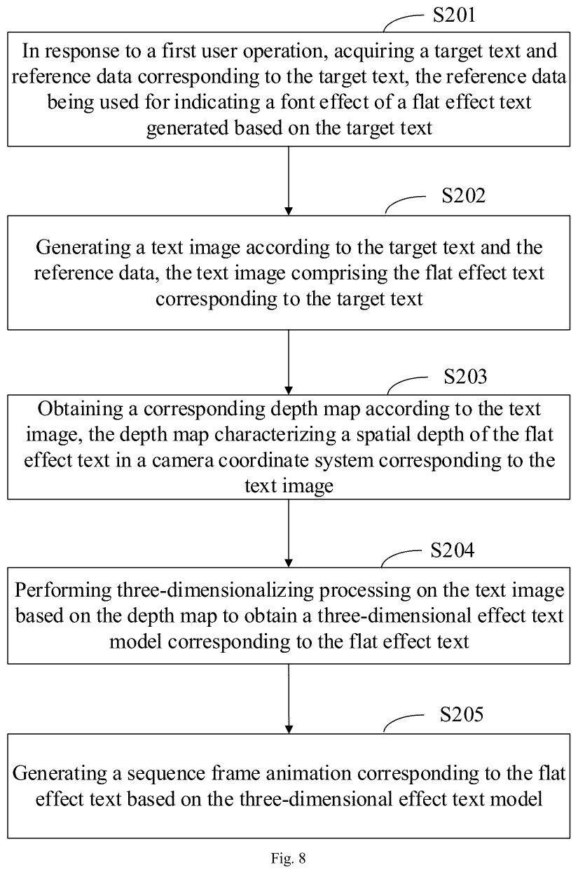

Referring to FIG. 8, FIG. 8 is a flowchart of another text animation generation method provided by an embodiment of the present disclosure. On the basis of the embodiment shown in FIG. 2, the embodiment shown in FIG. 8 further refines the step of generating the text animation, that is, step S103. For example, the text animation at least includes sequence frame animation, and the text animation generation method includes:

Step S201: in response to a first user operation, acquiring a target text and reference data corresponding to the target text, the reference data being used for indicating a font effect of a flat effect text generated based on the target text.

Step S202: generating a text image according to the target text and the reference data, the text image comprising the flat effect text corresponding to the target text.

Step S203: obtaining a corresponding depth map according to the text image, the depth map characterizing a spatial depth of the flat effect text in a camera coordinate system corresponding to the text image.

Step S204: performing three-dimensionalizing processing on the text image based on the depth map to obtain a three-dimensional effect text model corresponding to the flat effect text.

For example, depths usually refer to numerical values in a depth direction (Z direction) of a camera space for different objects in a picture taken through the camera due to the different objects respectively having different distances from the shooting point, that is, the Z coordinate in the camera coordinate system. The depth map can be a bitmap or a matrix used to represent the spatial depth of the above-mentioned flat effect text in the camera coordinate system corresponding to the flat text image. In one possible implementation, the size of the depth map is the same as that of the text image, each point (depth value) in the depth map corresponds to a pixel point in the text image, so as to represent the spatial depth of the flat effect text.

Furthermore, because the depth values in the depth map correspond to the pixel points in the text image one by one, the neighborhood information of the pixel points in the text image is completely inherited into the depth map, and then the neighborhood information of the pixel points can be combined with the depth map to achieve the three-dimensionalization of the flat effect text, so as to obtain the expression of the flat effect text in the three-dimensional space, that is, the three-dimensional effect text model corresponding to the flat effect text.

For example, the depth map can be obtained by processing the text image using a depth estimation algorithm, and the specific implementation of the depth estimation algorithm is not described here. In the steps of the embodiment, because the depth map only stores one depth value instead of three coordinate values of the three-dimensional point cloud, the three-dimensional spatial information matched with the text image can be expressed orderly with less storage space through the depth map, so as to improve the computational efficiency of the subsequent generated text animation. There are many implementations to achieve the algorithm (2D to 3D algorithm) for converting a 2D image into a 3D model in combination with the depth map, which can be set by those skilled in the art according to their needs, so that the details are not repeated here.

Optionally, after step S203, the method may further include:

Step S203A: segmenting the text image to obtain a transparent text image, the transparent text image comprising the flat effect text and a corresponding transparent background.

For example, before generating the three-dimensional effect text model based on the text image, the text image can be segmented first to remove the solid background other than the flat effect text in the text image to obtain the transparent text image that only includes the flat effect text and the corresponding transparent background, and then the three-dimensional effect text model can be generated based on the transparent text image to improve the model quality of the three-dimensional effect text model. Specifically, the outline of the flat effect text can be identified based on the change of the pixel points in the text image, and then the text image can be segmented to obtain the transparent text image with a transparent background. For example, the text image can also be processed by an image processing model such as the open source model U2Net to obtain the transparent text image with a transparent background, and the specific implementation method can be set as required and will not be repeated here.

Then, after the text image is segmented and the transparent text image is obtained, the corresponding three-dimensional effect text model can be generated through the transparent text image, that is, the transparent text image is three-dimensionalized based on the depth map to obtain the three-dimensional effect text model corresponding to the flat effect text. Because the solid background in the text image is removed, the accuracy of the contour edge of the flat effect text can be improved, the interference of the background can be reduced, and the model quality of the three-dimensional effect text model can be further improved.

Step S205: generating a sequence frame animation corresponding to the flat effect text based on the three-dimensional effect text model.

For example, after the three-dimensional effect text model is obtained, on the basis of the three-dimensional effect text model, two-dimensional mapping can be directly performed on the three-dimensional effect text model to obtain two-dimensional pictures in different shapes and viewing angles, and the sequence frame animation can be obtained after orderly arrangement. Or, based on the preset three-dimensional model engine or tool, physical simulation is carried out with the three-dimensional effect text model as input and batch rendering is carried out, so as to generate the sequence frame animation.

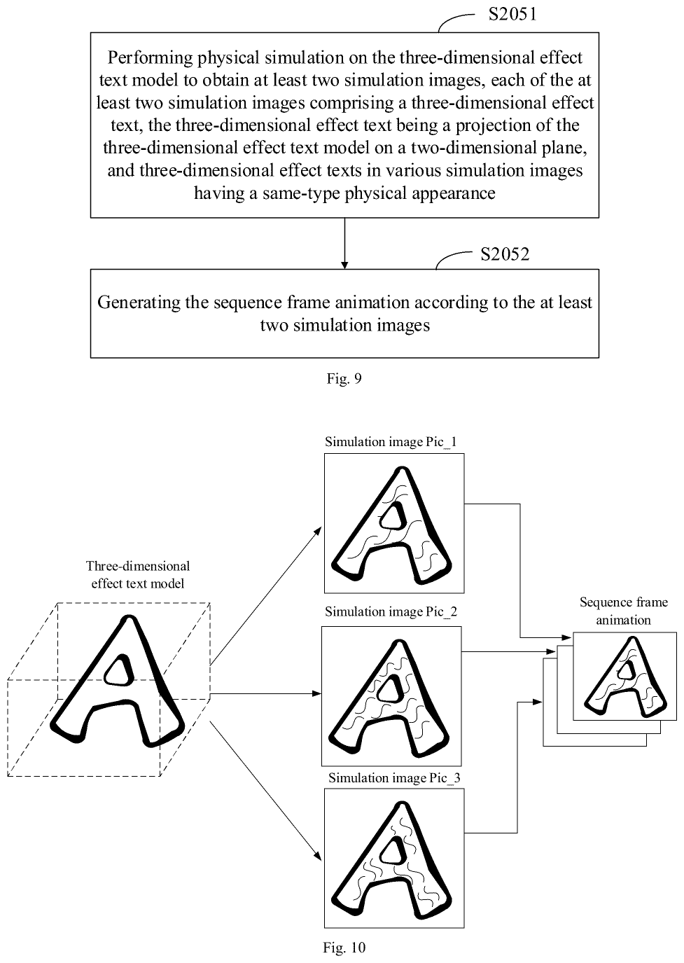

In one possible implementation, as shown in FIG. 9, the specific implementation of step S205 includes:

Step S2051: performing physical simulation on the three-dimensional effect text model to obtain at least two simulation images, each of the at least two simulation images comprising a three-dimensional effect text, the three-dimensional effect text being a projection of the three-dimensional effect text model on a two-dimensional plane, and three-dimensional effect texts in various simulation images having a same-type physical appearance.

Step S2052: generating the sequence frame animation according to the at least two simulation images.

For example, the physical simulation for a three-dimensional model refers to simulating the appearance of a real object to the appearance of a three-dimensional model, so that the appearance of the three-dimensional model has a real physical visual effect. Specifically, the types of the physical simulation include, for example, fluid, cloth, hair, soft body, rigid body, and so on. Through performing the physical simulation on the three-dimensional model, the appearance of the three-dimensional model is more realistic and the impression effect is improved. In the embodiment, the three-dimensional effect text with real physical appearance is generated by performing physical simulation on the three-dimensional effect text model and then performing two-dimensional projection (rendering), furthermore, the sequence frame animation is generated by orderly combination of a plurality of three-dimensional effect texts (corresponding simulation images) with the same physical appearance. The three-dimensional effect text refers to an effect text (as shown in the embodiment shown in FIG. 10) with a three-dimensional visual effect presented in a two-dimensional plane (picture). The process of performing physical simulation on the three-dimensional effect text model can be achieved by software or tool with three-dimensional drawing and rendering capabilities, which is not limited here.

FIG. 10 is a schematic diagram of generating a sequence frame animation provided by an embodiment of the present disclosure. As shown in FIG. 10, after obtaining the three-dimensional effect text model (shown as a three-dimensional model of the letter “A” in the figure), the physical simulation is performed on the three-dimensional effect text model by a three-dimensional model rendering tool to generate a plurality of simulation images, such as a simulation image Pic_1, a simulation image Pic_2, and a simulation image Pic_3 in the figure, respectively. Compared with the three-dimensional effect text model, the three-dimensional effect text in each simulation image is added with the physical appearance of “water ripple”, but at least two simulation images among various simulation images (such as the simulation image Pic_1, the simulation image Pic_2, and the simulation image Pic_3) are inconsistent. Then, the above-mentioned generated plurality of simulation images are combined in an orderly manner to obtain the sequence frame animation, that is, the text animation corresponding to the flat effect text, so as to implement the purpose of dynamic display of the effect text.

Further, in a possible implementation, the specific implementation of step S2051 includes:

Step S2051A: acquiring a target number of a simulation image to be generated.

Step S2051B: according to the target number, performing the physical simulation on the three-dimensional effect text model, and generating a corresponding simulation image based on a trigger timing sequence of the physical simulation performed for the three-dimensional effect text model, a physical appearance of the three-dimensional effect text in the simulation image being determined by the trigger timing sequence corresponding to the simulation image.

Illustratively, the steps in the embodiment provide a more specific implementation to perform physical simulation on the three-dimensional effect text model. First, the target number of the simulation images to be generated is obtained, the target number can be set manually according to the user's needs. Then, based on the target number, the three-dimensional model rendering tool is called to perform physical simulation on the three-dimensional effect text model for multiple times, that is, multiple times of rendering, so as to obtain a plurality of frames of simulation images. At the same time, during the rendering process, taking the rendering trigger timing sequence as an image generation parameter, the simulation images corresponding to the trigger timing sequence are generated. For example, when rendering the three-dimensional effect text, the system time of each trigger rendering is called, and the corresponding simulation images are generated by taking the system time as an image generation parameter, so that the physical appearances of successively generated simulation images have a correlation corresponding to the time sequence characteristics. Because the trigger timing sequence is continuous, the physical appearance of the successively generated simulation images shows continuous and regular changes.

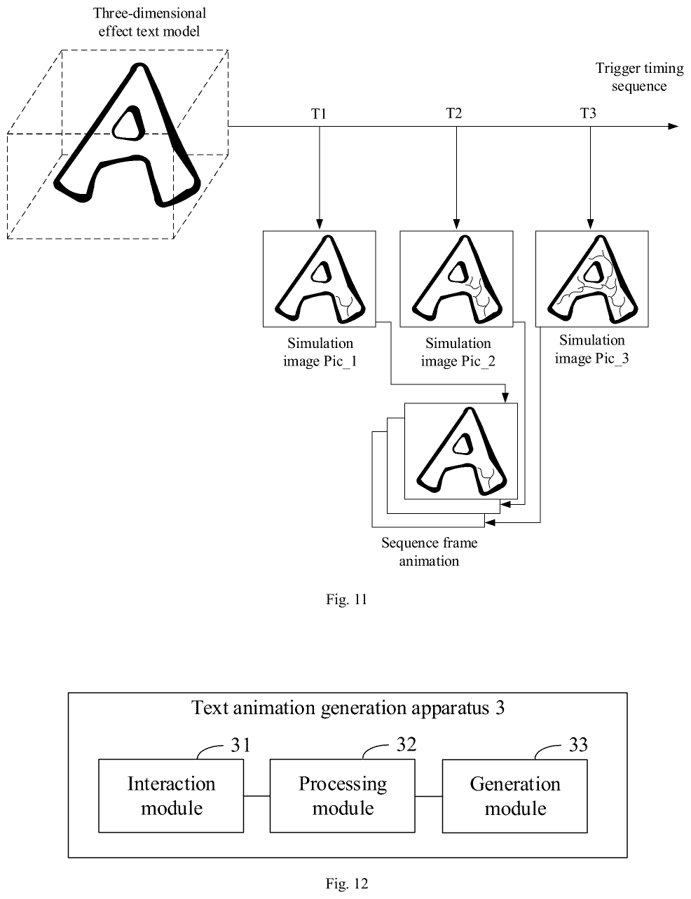

FIG. 11 is a schematic diagram of a process for generating a plurality of simulation images provided by an embodiment of the present disclosure, and the above process will be further introduced in combination with FIG. 11 below. For example, after obtaining a three-dimensional effect text model (shown as a three-dimensional model of the letter “A” in the figure), the three-dimensional effect text model is physically simulated by a three-dimensional model rendering tool to generate a plurality of simulation images, respectively, for example, a simulation image Pic_1, a simulation image Pic_2, and a simulation image Pic_3 in the figure, the three-dimensional effect texts in the above-mentioned simulation images have the same-type physical appearance, that is, the physical appearance of “crack” (added relative to the three-dimensional effect text model), the simulation image Pic_1 is rendered at time T1, the simulation image Pic_2 is rendered at time T2, and the simulation image Pic_3 is rendered at time T3, because time T1 is less than time T2 and time T2 is less than time T3, correspondingly, the physical appearance of the three-dimensional effect text in the simulation image Pic_1 is the physical appearance ap_1 with a relatively small “crack”, the physical appearance of the three-dimensional effect text in the simulation image Pic_2 is the physical appearance ap_2 with a medium “crack”, and the physical appearance of the three-dimensional effect text in the simulation image Pic_3 is the physical appearance ap_3 with a relatively large “crack”. That is to say, the physical appearance of the three-dimensional effect text generated after performing physical simulation is related to the timing of triggering the physical simulation. Then, based on the ordered set of the simulation image Pic_1, the simulation image Pic_2, and the simulation image Pic_3, the dynamic effect text with continuous changes of “cracks” is obtained, that is, the sequence frame animation (text animation).

In the steps of the embodiment, in the process of performing physical simulation on the three-dimensional effect text model and generating the sequence frame animation, the corresponding simulation image is generated based on the trigger timing sequence of physical simulation for the three-dimensional effect text model. Because of the continuity of the trigger timing sequence, when the corresponding simulation image is generated by taking the trigger timing sequence as an image generation parameter, there is also continuity in content among the obtained plurality of simulation images. Therefore, the physical appearance of the three-dimensional effect text presents a continuously changing visual effect, so that the final generated sequence frame animation (text animation) can show a more realistic physical effect and improve the expressive force.

In the embodiment, the implementation methods of steps S201-S202 are the same as those of steps S101-S102 in the embodiment shown in FIG. 2 of the present disclosure, and will not be repeated herein.

Corresponding to the text animation generation method of the above embodiment, FIG. 12 is a structural block diagram of a text animation generation apparatus provided by an embodiment of the present disclosure. For convenience of explanation, only parts related to the embodiment of the present disclosure are shown. Referring to FIG. 12, the text animation generation apparatus 3 includes:
an interaction module 31, configured to: in response to a first user operation, acquire a target text and reference data corresponding to the target text, the reference data being used for indicating a font effect of an effect text generated based on the target text;
a processing module 32, configured to generate a text image according to the target text and the reference data, the text image comprising the effect text corresponding to the target text; and
a generation module 33, configured to generate a text animation corresponding to the effect text according to the text image.

In one embodiment of the present disclosure, the reference data comprises a font file based on a target language; the processing module 32 is specifically used for generating an input image according to the target text and the font file; and generating the text image according to the input image and a generative model.

In one embodiment of the present disclosure, the reference data comprises texture information, and the texture information characterizes texture features of the input image; when the processing module 32 generates the input image according to the target text and the font file, the processing module 32 is specifically used to: obtain a glyph outline according to the target text and the font file; and perform texture overlaying on the glyph outline based on the texture information to generate the input image.

In one embodiment of the present disclosure, the reference data comprises mask information, the mask information is used to characterize a display region of the input image; when the processing module 32 generates the input image according to the target text and the font file, the processing module 32 is specifically used to: obtain a text picture according to the target text and the font file; and generate the input image through a mask map corresponding to the mask information and the text picture.

In one embodiment of the present disclosure, the interaction module 31 is further configured to obtain description word information in response to a second user operation; when the processing module 32 generates the text image according to the input image and the generative model, the processing module 32 is specifically used to process the description word information and the input image through the generative model that is pre-trained to generate the text image.

In one embodiment of the present disclosure, before the processing the description word information and the input image through the generative model that is pre-trained to generate the text image, the interaction module 31 is further used to configure a model plug-in for the generative model in response to a third user operation, and the model plug-in is used for enabling the generative model to generate an image with a target image style.

In one embodiment of the present disclosure, the text animation at least comprises a two-dimensional skeleton animation, and the two-dimensional skeleton animation is used for showing glyph change of the effect text; the generation module 33 is specifically used for: acquiring an initial skeleton animation template, the skeleton animation template comprising a skeleton model and at least one key frame, and the key frame being used for characterizing a shape of the skeleton model at a corresponding moment; and mapping the text image to the skeleton animation template and binding the effect text with the skeleton model, to obtain the two-dimensional skeleton animation corresponding to the key frame.

In one embodiment of the present disclosure, the effect text in the text image is a flat effect text, the text animation at least comprises a sequence frame animation, and the generation module 33 is specifically used for: obtaining a corresponding depth map according to the text image, the depth map characterizing a spatial depth of the effect text in a camera coordinate system corresponding to the text image; performing three-dimensionalizing processing on the text image based on the depth map to obtain a three-dimensional effect text model corresponding to the effect text; and generating the sequence frame animation corresponding to the effect text based on the three-dimensional effect text model.

In one embodiment of the present disclosure, when the generation module 33 generates the sequence frame animation corresponding to the effect text based on the three-dimensional effect text model, the generation module 33 is specifically used for: performing physical simulation on the three-dimensional effect text model to obtain at least two simulation images, each of the at least two simulation images comprising a three-dimensional effect text, the three-dimensional effect text being a projection of the three-dimensional effect text model on a two-dimensional plane, and three-dimensional effect texts in the simulation images having the same-type physical appearance; and generating the sequence frame animation according to the at least two simulation images.

In one embodiment of the present disclosure, when the generation module 33 performs physical simulation on the three-dimensional effect text model to obtain at least two simulation images, the generation module 33 is specifically used to: acquire a target number of a simulation image to be generated; and according to the target number, perform the physical simulation on the three-dimensional effect text model, and generate a corresponding simulation image based on a trigger timing sequence of the physical simulation performed for the three-dimensional effect text model, a physical appearance of the three-dimensional effect text in the simulation image being determined by the trigger timing sequence corresponding to the simulation image.

In one embodiment of the present disclosure, the generation module 33 is further configured to: segment the text image to obtain a transparent text image, the transparent text image comprises the effect text and a corresponding transparent background; when the generation module 33 performs three-dimensionalizing processing on the text image based on the depth map to obtain the three-dimensional effect text model corresponding to the effect text, the generation module 33 is specifically used to perform three-dimensionalizing processing on the transparent text image based on the depth map to obtain the three-dimensional effect text model corresponding to the effect text.

The interaction module 31, the processing module 32, and the generation module 33 are connected in sequence. The text animation generation apparatus 3 provided by the embodiment can execute the technical solution of the above method embodiment, and its implementation principle and technical effect are similar, so the embodiment does not repeat the details here.

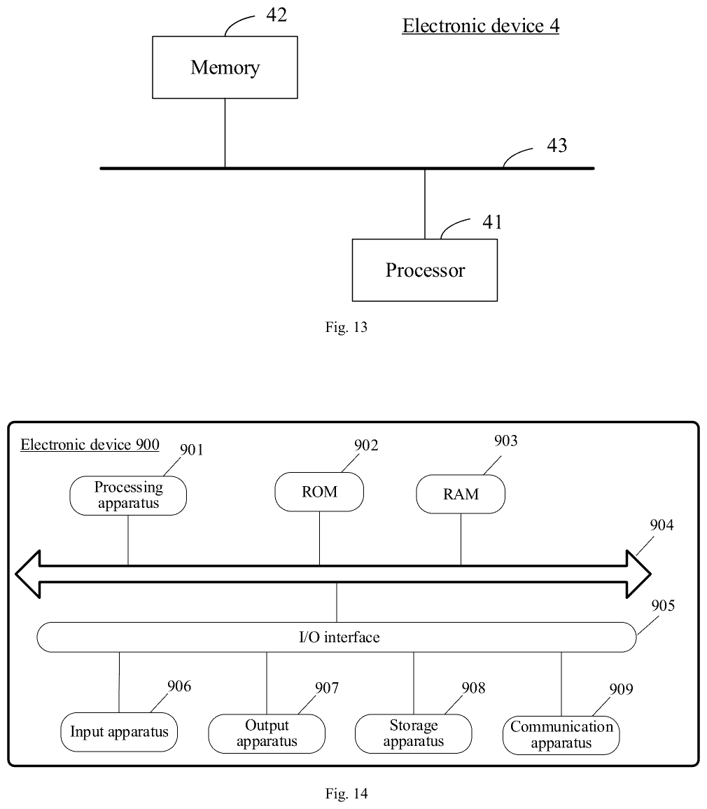

FIG. 13 is a schematic structural diagram of an electronic device provided by an embodiment of the present disclosure. As shown in FIG. 13, the electronic device 4 includes: a processor 41 and a memory 42 connected in communication with the processor 41.

The memory 42 store computer executable instructions.

The processor 41 executes the computer executable instructions stored in the memory 42 to implement the text animation generation method in the embodiments shown in FIGS. 2-11.

Alternatively, the processor 41 and the memory 42 are connected by a bus 43.

The related descriptions can be understood by referring to the related descriptions and effects of the steps in the embodiments corresponding to FIG. 2-FIG. 11, and will not be repeated here.

An embodiment of the present disclosure provides a non-transitory computer-readable storage medium, the non-transitory computer-readable storage medium stores computer executable instructions, and the computer executable instructions, when executed by a processor, are used to implement the text animation generation method provided by any one of the embodiments corresponding to FIGS. 2 to 11 of the present disclosure.

In order to implement the above embodiment, the embodiment of the present disclosure also provides an electronic device.

Referring to FIG. 14, which shows a structural schematic diagram of an electronic device 900 suitable for implementing the embodiments of the present disclosure, the electronic device 900 may be a terminal device or a server. The terminal device may include, but is not limited to, mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), or the like, and fixed terminals such as a digital TV, a desktop computer, or the like. The electronic device shown in FIG. 14 is just an example, and should not bring any limitation to the function and application scope of the embodiments of the present disclosure.

As shown in FIG. 14, the electronic device 900 can include a processing apparatus 901 (e.g., a central processing unit, a graphics processing unit, etc.), which can perform various suitable actions and processing according to a program stored in a read-only memory (ROM) 902 or a program loaded from a storage apparatus 908 into a random-access memory (RAM) 903. The RAM 903 further stores various programs and data required for operations of the electronic device 900. The processing apparatus 901, the ROM 902, and the RAM 903 are interconnected to each other by means of the bus 904. An input/output (I/O) interface 905 is also connected to the bus 904.

Usually, the following apparatus can be connected to the I/O interface 905: an input apparatus 906 including, for example, a touch screen, a touch pad, a keyboard, a mouse, a camera, a microphone, an accelerometer, a gyroscope, or the like; an output apparatus 907 including, for example, a liquid crystal display (LCD), a loudspeaker, a vibrator, or the like; a storage apparatus 908 including, for example, a magnetic tape, a hard disk, or the like; and a communication apparatus 909. The communication apparatus 909 may allow the electronic device 900 to be in wireless or wired communication with other devices to exchange data. While FIG. 14 illustrates the electronic device 900 having various apparatuses, it should be understood that not all of the illustrated apparatuses are necessarily implemented or included. More or fewer apparatuses may be implemented or provided alternatively.

Particularly, according to the embodiments of the present disclosure, the processes described above with reference to the flowcharts can be implemented as a computer software program. For example, the embodiments of the present disclosure include a computer program product, which includes a computer program carried on a computer-readable medium. The computer program includes program codes for performing the methods shown in the flowcharts. In such embodiments, the computer program may be downloaded from the network through the communication apparatus 909 and installed, or may be installed from the storage apparatus 908, or may be installed from the ROM 902. When the computer program is executed by the processing apparatus 901, the above-mentioned functions defined in the method of the embodiments of the present disclosure are performed.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semi-conductive system, apparatus, or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier wave and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate, or transmit a program used by or in combination with an instruction execution system, apparatus, or device. The program code contained on the computer-readable medium may be transmitted by using any suitable medium, including but not limited to an electric wire, a fiber-optic cable, radio frequency (RF) and the like, or any appropriate combination of them.

The above-mentioned computer-readable medium may be included in the above-mentioned electronic device, or may also exist alone without being assembled into the electronic device.

The above-mentioned computer-readable medium carries one or more programs, when the one or more programs are executed by the electronic device, the electronic device is caused to perform the method shown in the above-described embodiments.

The computer program codes for performing the operations of the present disclosure can be written in one or more programming languages or a combination thereof. The above-mentioned programming languages include object-oriented programming languages such as Java, Smalltalk, C++, and also include conventional procedural programming languages such as the “C” programming language or similar programming languages. The program code can be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or to an external computer (for example, through the Internet using an Internet service provider).

The flowcharts and block diagrams in the accompanying drawings illustrate system architectures, functions, and operations that may be implemented by the system, method, and computer program products according to the various embodiments of the present disclosure. In this regard, each block in the flowcharts or block diagrams may represent a module, a program segment, or a part of code, and the module, the program segment, or the part of code includes one or more executable instructions for implementing specified logic functions. It should also be noted that, in some alternative implementations, functions marked in the blocks may also occur in an order different from the order designated in the accompanying drawings. For example, two consecutive blocks can actually be executed substantially in parallel, and they may sometimes be executed in a reverse order, which depends on involved functions. It should also be noted that each block in the block diagrams and/or flowcharts and combinations of the blocks in the block diagrams and/or flowcharts may be implemented by a dedicated hardware-based system for executing specified functions or operations, or may be implemented by a combination of a dedicated hardware and computer instructions.

The units involved in the embodiments described in the present disclosure may be implemented by software, or may be implemented by hardware. The name of a unit does not constitute a limitation on the unit itself. For example, the first obtaining unit may also be described as “a unit that obtains at least two Internet protocol addresses”.

The functions described above in the present disclosure may be executed at least in part by one or more hardware logic components. For example, without limitations, exemplary types of the hardware logic components that can be used include: a field-programmable gate array (FPGA), an application specific integrated circuit (ASIC), an application specific standard product (ASSP), a system on chip (SOC), a complex programmable logic device (CPLD), and the like.

In the context of the present disclosure, a machine readable medium may be a tangible medium that may contain or store a program for use by or in combination with an instruction execution system, apparatus, or device. The machine readable medium may be a machine readable signal medium or a machine readable storage medium. The machine readable medium may include but not be limited to an electronic, magnetic, optical, electromagnetic, infrared, or semi-conductive system, apparatus, or device, or any appropriate combination of them. More specific examples of the machine readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any appropriate combination of them.

According to one or more embodiments of the present disclosure, a text animation generation method is provided and includes:
in response to a first user operation, acquiring a target text and reference data corresponding to the target text, the reference data being used for indicating a font effect of an effect text generated based on the target text; generating a text image according to the target text and the reference data, the text image comprising the effect text corresponding to the target text; and generating a text animation corresponding to the effect text according to the text image.

According to one or more embodiments of the present disclosure, the reference data comprises a font file based on a target language; the generating a text image according to the target text and the reference data comprises: generating an input image according to the target text and the font file; and generating the text image according to the input image and a generative model.

According to one or more embodiments of the present disclosure, the reference data comprises texture information, and the texture information characterizes texture features of the input image; the generating an input image according to the target text and the font file comprises: obtaining a glyph outline according to the target text and the font file; and performing texture overlaying on the glyph outline based on the texture information to generate the input image.

According to one or more embodiments of the present disclosure, the reference data comprises mask information, the mask information is used to characterize a display region of the input image; the generating an input image according to the target text and the font file comprises: obtaining a text picture according to the target text and the font file; and generating the input image through a mask map corresponding to the mask information and the text picture.

According to one or more embodiments of the present disclosure, the method further includes obtaining description word information in response to a second user operation; the generating the text image according to the input image and a generative model comprises: processing the description word information and the input image through the generative model that is pre-trained to generate the text image.

According to one or more embodiments of the present disclosure, before the processing the description word information and the input image through the generative model that is pre-trained to generate the text image, the method further comprises: configuring a model plug-in for the generative model in response to a third user operation, the model plug-in being used for enabling the generative model to generate an image with a target image style.

According to one or more embodiments of the present disclosure, the text animation at least comprises a two-dimensional skeleton animation, and the two-dimensional skeleton animation is used for showing glyph change of the effect text, the generating a text animation corresponding to the effect text according to the text image comprises: acquiring a skeleton animation template that is initial, the skeleton animation template comprising a skeleton model and at least one key frame, and the key frame is used for characterizing a shape of the skeleton model at a corresponding moment; and mapping the text image to the skeleton animation template and binding the effect text with the skeleton model, to obtain the two-dimensional skeleton animation corresponding to the key frame.

According to one or more embodiments of the present disclosure, the text animation at least comprises a sequence frame animation, and the generating a text animation corresponding to the effect text according to the text image comprises: obtaining a corresponding depth map according to the text image, the corresponding depth map characterizing a spatial depth of the effect text in a camera coordinate system corresponding to the text image; performing three-dimensionalizing processing on the text image based on the corresponding depth map to obtain a three-dimensional effect text model corresponding to the effect text; and generating the sequence frame animation corresponding to the effect text based on the three-dimensional effect text model.

According to one or more embodiments of the present disclosure, the generating the sequence frame animation corresponding to the effect text based on the three-dimensional effect text model comprises: performing physical simulation on the three-dimensional effect text model to obtain at least two simulation images, each of the at least two simulation images comprising a three-dimensional effect text, the three-dimensional effect text being a projection of the three-dimensional effect text model on a two-dimensional plane, and three-dimensional effect texts in the various simulation images having the same-type physical appearance; and generating the sequence frame animation according to the at least two simulation images.

According to one or more embodiments of the present disclosure, the performing physical simulation on the three-dimensional effect text model to obtain at least two simulation images comprises: acquiring a target number of a simulation image to be generated; and according to the target number, performing the physical simulation on the three-dimensional effect text model, and generating a corresponding simulation image based on a trigger timing sequence of the physical simulation performed for the three-dimensional effect text model, a physical appearance of the three-dimensional effect text in the simulation image being determined by the trigger timing sequence corresponding to the simulation image.

According to one or more embodiments of the present disclosure, the method further comprises: segmenting the text image to obtain a transparent text image, the transparent text image comprising the effect text and a corresponding transparent background; performing three-dimensionalizing processing on the text image based on the corresponding depth map to obtain a three-dimensional effect text model corresponding to the effect text comprises: performing three-dimensionalizing processing on the transparent text image based on the corresponding depth map to obtain the three-dimensional effect text model corresponding to the effect text.

According to one or more embodiments of the present disclosure, a text animation generation apparatus is provided and includes:
an interaction module, configured to: in response to a first user operation, acquire a target text and reference data corresponding to the target text, the reference data being used for indicating a font effect of an effect text generated based on the target text;
a processing module, configured to generate a text image according to the target text and the reference data, the text image comprising the effect text corresponding to the target text; and
a generation module, configured to generate a text animation corresponding to the effect text according to the text image.

According to one or more embodiments of the present disclosure, the reference data comprises a font file based on a target language; the processing module is specifically configured to generate an input image according to the target text and the font file; and generate the text image according to the input image and a generative model.

According to one or more embodiments of the present disclosure, the reference data comprises texture information, and the texture information characterizes texture features of the input image; when the processing module generates the input image according to the target text and the font file, the processing module is specifically configured to: obtain a glyph outline according to the target text and the font file; and perform texture overlaying on the glyph outline based on the texture information to generate the input image.

According to one or more embodiments of the present disclosure, the reference data comprises mask information, the mask information is used to characterize a display region of the input image; when the processing module generates the input image according to the target text and the font file, the processing module is specifically configured to: obtain a text picture according to the target text and the font file; and generate the input image through a mask map corresponding to the mask information and the text picture.

According to one or more embodiments of the present disclosure, the interaction module is further configured to obtain description word information in response to a second user operation; when the processing module generates the text image according to the input image and the generative model, the processing module is specifically configured to process the description word information and the input image through the generative model that is pre-trained to generate the text image.

According to one or more embodiments of the present disclosure, before the processing the description word information and the input image through the generative model that is pre-trained to generate the text image, the interaction module is further configured to configure a model plug-in for the generative model in response to a third user operation, and the model plug-in is used for enabling the generative model to generate an image with a target image style.

According to one or more embodiments of the present disclosure, the text animation at least comprises a two-dimensional skeleton animation, and the two-dimensional skeleton animation is used for showing glyph change of the effect text; the generation module is specifically configured to: acquire an initial skeleton animation template, the skeleton animation template comprising a skeleton model and at least one key frame, and the key frame being used for characterizing a shape of the skeleton model at a corresponding moment; and map the text image to the skeleton animation template and bind the effect text with the skeleton model, to obtain the two-dimensional skeleton animation corresponding to the key frame.

According to one or more embodiments of the present disclosure, the text animation at least comprises a sequence frame animation, and the generation module is specifically configured to: obtain a corresponding depth map according to the text image, the depth map characterizing a spatial depth of the effect text in a camera coordinate system corresponding to the text image; perform three-dimensionalizing processing on the text image based on the depth map to obtain a three-dimensional effect text model corresponding to the effect text; and generate the sequence frame animation corresponding to the effect text based on the three-dimensional effect text model.

According to one or more embodiments of the present disclosure, when the generation module generates the sequence frame animation corresponding to the effect text based on the three-dimensional effect text model, the generation module is specifically configured to: perform physical simulation on the three-dimensional effect text model to obtain at least two simulation images, each of the at least two simulation images comprising a three-dimensional effect text, the three-dimensional effect text being a projection of the three-dimensional effect text model on a two-dimensional plane, and three-dimensional effect texts in the simulation images having the same-type physical appearance; and generate the sequence frame animation according to the at least two simulation images.

According to one or more embodiments of the present disclosure, when the generation module performs physical simulation on the three-dimensional effect text model to obtain at least two simulation images, the generation module is specifically configured to: acquire a target number of a simulation image to be generated; and according to the target number, perform the physical simulation on the three-dimensional effect text model, and generate a corresponding simulation image based on a trigger timing sequence of the physical simulation performed for the three-dimensional effect text model, a physical appearance of the three-dimensional effect text in the simulation image being determined by the trigger timing sequence corresponding to the simulation image.

According to one or more embodiments of the present disclosure, the generation module is further configured to: segment the text image to obtain a transparent text image, the transparent text image comprises the effect text and a corresponding transparent background; when the generation module performs three-dimensionalizing processing on the text image based on the depth map to obtain the three-dimensional effect text model corresponding to the effect text, the generation module is specifically configured to perform three-dimensionalizing processing on the transparent text image based on the depth map to obtain the three-dimensional effect text model corresponding to the effect text.

According to one or more embodiments of the present disclosure, an electronic device is provided and includes at least one processor and a memory.

The memory stores computer executable instructions.

The at least one processor executes the computer executable instructions stored in the memory, so that the at least one processor executes the text animation generation method according to any embodiment of the present disclosure.

According to one or more embodiments of the present disclosure, a computer-readable storage medium is provided, the computer-readable storage medium stores computer executable instructions, and when the computer executable instructions are executed by a processor, the text animation generation method according to any embodiment of the present disclosure is implemented.

According to one or more embodiments of the present disclosure, a computer program product is provided and includes a computer program, and the computer program, when executed by a processor, implements the text animation generation method according to any embodiment of the present disclosure.

The foregoing descriptions are merely the illustrations of the preferred embodiments of the present disclosure and the explanations of the applied technical principles. Those skilled in the art should understand that the scope of the disclosure involved in the present disclosure is not limited to the technical solutions formed by a specific combination of the technical features described above, and shall also cover other technical solutions formed by any combination of the technical features described above or equivalent features thereof without departing from the invention concept of the present disclosure. For example, the technical features described above may be mutually replaced with the technical features having similar functions disclosed herein (but not limited thereto) to form new technical solutions.

In addition, although operations have been described in a particular order, it shall not be construed as requiring that such operations are performed in the stated particular order or in a sequential order. Under certain circumstances, multitasking and parallel processing may be advantageous. Similarly, although some specific implementation details are included in the above discussions, these shall not be construed as limitations to the scope of the present disclosure. Some features described in the context of a separate embodiment may also be implemented in combination in a single embodiment. Conversely, various features described in the context of a single embodiment may also be implemented in various embodiments individually or in a plurality of embodiments in any appropriate sub-combination.

Although the present subject matter has been described in a language specific to structural features and/or method logical acts, it will be appreciated that the subject matter defined in the appended claims is not necessarily limited to the particular features or acts described above. Rather, the particular features and acts described above are merely exemplary forms for implementing the claims.

1. A text animation generation method, comprising:
in response to a first user operation, acquiring a target text and reference data corresponding to the target text, wherein the reference data is used for indicating a font effect of an effect text generated based on the target text;
generating a text image according to the target text and the reference data, wherein the text image comprises the effect text corresponding to the target text; and
generating a text animation corresponding to the effect text according to the text image.

2. The method according to claim 1, wherein the reference data comprises a font file based on a target language; the generating a text image according to the target text and the reference data comprises:
generating an input image according to the target text and the font file; and
generating the text image according to the input image and a generative model.

3. The method according to claim 2, wherein the reference data comprises texture information, and the texture information characterizes texture features of the input image; the generating an input image according to the target text and the font file comprises:
obtaining a glyph outline according to the target text and the font file; and
performing texture overlaying on the glyph outline based on the texture information to generate the input image.

4. The method according to claim 2, wherein the reference data comprises mask information, the mask information is used to characterize a display region of the input image; the generating an input image according to the target text and the font file comprises:
obtaining a text picture according to the target text and the font file; and
generating the input image through a mask map corresponding to the mask information and the text picture.

5. The method according to claim 2, further comprising:
obtaining description word information in response to a second user operation;
wherein the generating the text image according to the input image and a generative model comprises:
processing the description word information and the input image through the generative model that is pre-trained to generate the text image.

6. The method according to claim 5, wherein before the processing the description word information and the input image through the generative model that is pre-trained to generate the text image, the method further comprises:
configuring a model plug-in for the generative model in response to a third user operation, wherein the model plug-in is used for enabling the generative model to generate an image with a target image style.

7. The method according to claim 1, wherein the text animation at least comprises a two-dimensional skeleton animation, and the two-dimensional skeleton animation is used for showing glyph change of the effect text, the generating a text animation corresponding to the effect text according to the text image comprises:
acquiring a skeleton animation template that is initial, wherein the skeleton animation template comprises a skeleton model and at least one key frame, and the key frame is used for characterizing a shape of the skeleton model at a corresponding moment; and
mapping the text image to the skeleton animation template and binding the effect text with the skeleton model, to obtain the two-dimensional skeleton animation corresponding to the key frame.

8. The method according to claim 1, wherein the effect text in the text image is a flat effect text, the text animation at least comprises a sequence frame animation, and the generating a text animation corresponding to the effect text according to the text image comprises:
obtaining a corresponding depth map according to the text image, wherein the corresponding depth map characterizes a spatial depth of the effect text in a camera coordinate system corresponding to the text image;
performing three-dimensionalizing processing on the text image based on the corresponding depth map to obtain a three-dimensional effect text model corresponding to the effect text; and
generating the sequence frame animation corresponding to the effect text based on the three-dimensional effect text model.

9. The method according to claim 8, wherein the generating the sequence frame animation corresponding to the effect text based on the three-dimensional effect text model comprises:
performing physical simulation on the three-dimensional effect text model to obtain at least two simulation images, wherein each of the at least two simulation images comprises a three-dimensional effect text, the three-dimensional effect text is a projection of the three-dimensional effect text model on a two-dimensional plane, and three-dimensional effect texts in at least part of the at least two simulation images have a same-type physical appearance; and
generating the sequence frame animation according to the at least two simulation images.

10. The method according to claim 9, wherein the performing physical simulation on the three-dimensional effect text model to obtain at least two simulation images comprises:
acquiring a target number of a simulation image to be generated; and
according to the target number, performing the physical simulation on the three-dimensional effect text model, and generating a corresponding simulation image based on a trigger timing sequence of the physical simulation performed for the three-dimensional effect text model, wherein a physical appearance of the three-dimensional effect text in the simulation image is determined by the trigger timing sequence corresponding to the simulation image.

11. The method according to claim 8, further comprising:
segmenting the text image to obtain a transparent text image, wherein the transparent text image comprises the effect text and a corresponding transparent background;
the performing three-dimensionalizing processing on the text image based on the corresponding depth map to obtain a three-dimensional effect text model corresponding to the effect text comprises:
performing three-dimensionalizing processing on the transparent text image based on the corresponding depth map to obtain the three-dimensional effect text model corresponding to the effect text.

12. An electronic device, comprising: a processor and a memory;
wherein the memory stores computer executable instructions;
the processor executes the computer executable instructions stored in the memory, causing the processor to execute a text animation generation method, and the text animation generation method comprises:
in response to a first user operation, acquiring a target text and reference data corresponding to the target text, wherein the reference data is used for indicating a font effect of an effect text generated based on the target text;
generating a text image according to the target text and the reference data, wherein the text image comprises the effect text corresponding to the target text; and
generating a text animation corresponding to the effect text according to the text image.

13. The electronic device according to claim 12, wherein the reference data comprises a font file based on a target language; when performing a step of generating a text image according to the target text and the reference data, the processor is configured to:
generate an input image according to the target text and the font file; and
generate the text image according to the input image and a generative model.

14. The electronic device according to claim 13, wherein the reference data comprises texture information, and the texture information characterizes texture features of the input image; when performing a step of generating an input image according to the target text and the font file, the processor is configured to:
obtain a glyph outline according to the target text and the font file; and
perform texture overlaying on the glyph outline based on the texture information to generate the input image.

15. The electronic device according to claim 13, wherein the reference data comprises mask information, the mask information is used to characterize a display region of the input image; when performing a step of generating an input image according to the target text and the font file, the processor is configured to:
obtain a text picture according to the target text and the font file; and
generate the input image through a mask map corresponding to the mask information and the text picture.

16. The electronic device according to claim 13, wherein the method further comprises:
obtaining description word information in response to a second user operation;
wherein when performing a step of generating the text image according to the input image and a generative model, the processor is configured to:
process the description word information and the input image through the generative model that is pre-trained to generate the text image.

17. The electronic device according to claim 16, wherein before the processing the description word information and the input image through the generative model that is pre-trained to generate the text image, the method further comprises:
configuring a model plug-in for the generative model in response to a third user operation, wherein the model plug-in is used for enabling the generative model to generate an image with a target image style.

18. The electronic device according to claim 12, wherein the text animation at least comprises a two-dimensional skeleton animation, and the two-dimensional skeleton animation is used for showing glyph change of the effect text, when performing a step of generating a text animation corresponding to the effect text according to the text image, the processor is configured to:
acquire a skeleton animation template that is initial, wherein the skeleton animation template comprises a skeleton model and at least one key frame, and the key frame is used for characterizing a shape of the skeleton model at a corresponding moment; and
map the text image to the skeleton animation template and bind the effect text with the skeleton model, to obtain the two-dimensional skeleton animation corresponding to the key frame.

19. The electronic device according to claim 12, wherein the effect text in the text image is a flat effect text, the text animation at least comprises a sequence frame animation, and when performing a step of generating a text animation corresponding to the effect text according to the text image, the processor is configured to:
obtain a corresponding depth map according to the text image, wherein the corresponding depth map characterizes a spatial depth of the effect text in a camera coordinate system corresponding to the text image;
perform three-dimensionalizing processing on the text image based on the corresponding depth map to obtain a three-dimensional effect text model corresponding to the effect text; and
generate the sequence frame animation corresponding to the effect text based on the three-dimensional effect text model.

20. A non-transitory computer-readable storage medium, wherein the non-transitory computer-readable storage medium stores computer executable instructions,
when a processor executes the computer executable instructions, a text animation generation method is implemented, and the text animation generation method comprises:
in response to a first user operation, acquiring a target text and reference data corresponding to the target text, wherein the reference data is used for indicating a font effect of an effect text generated based on the target text;
generating a text image according to the target text and the reference data, wherein the text image comprises the effect text corresponding to the target text; and
generating a text animation corresponding to the effect text according to the text image.
